(19) United States
(12) Patent Application Publication
(10) Pub. No.: US 2004/0243396 A1
(43) Pub. Date: Dec. 2, 2004

(54) User-oriented electronic dictionary, electronic dictionary system and method for creating same

(75) Inventors: Shixia Liu, Beijing (CN); Liping Yang, Beijing (CN)

Correspondence Address: Louis P. Herzberg, Intellectual Property Law Dept., IBM Corporation, P.O. Box 218, Yorktown Heights, NY, 10598, US

(73) Assignee: International Business Machines Corporation, Armonk, NY

(21) Appl. No.: 10/739,780

(22) Filed: May 20, 2004

(30) Foreign Application Priority Data
Dec. 30, 2002 (CN) 02160014.7

(51) Int. Cl. G06F 17/21

(52) U.S. Cl. 704/10

(57) ABSTRACT

The invention provides a user-oriented electronic dictionary, an electronic dictionary system and a method for creating the same, in which users may freely modify (add or delete) attributes of a lemma in the electronic dictionary. In the present invention, the entity instances generated from a entity object are used to indicate the information related to a lemma in said electronic dictionary, and the relation instances generated from a relation object are used to indicate the directed relations between two entity instances. Therefore, in the electronic dictionary according to the present invention, all entity instances related to a lemma in said electronic dictionary are linked by the corresponding relation instances to form a directed relation graph. The electronic dictionary according to the present invention promises better reusability and maintainability.

### FIELD OF INVENTION

The present invention relates to the field of information processing, more specifically, to an electronic dictionary, an electronic dictionary system and a method for creating same, which are used in the field of information processing.

### BACKGROUND OF THE INVENTION

Electronic dictionaries are widely used in information processing field. Generally speaking, an electronic dictionary may be used as an information library for collecting data attributes, data usages and relations with other data. However, different applications may have different requirements for lemmas in a dictionary. For example, for an electronic dictionary widely used in text processing of, such as, machine translation systems, information retrieval systems or natural-language understanding systems, one application may require lemmas in a dictionary to indicate part-of-speeches and stems, while another application may require lemmas in a dictionary to contain the word's meanings and semantic relations. And with the further development of these applications, the requirements may change.

Furthermore, for the electronic dictionaries provided in portable pervasive computing devices, such as electronic commerce assistants and personal digital assistants, different users may also have different requirements for the lemmas in those dictionaries due to the nature of their work or their business fields. Therefore, it is extremely important for electronic dictionaries to provide good reusability and maintainability.

In prior known electronic dictionary systems, all necessary attributes of a word (such as meaning, part-of-speech, stem, pronunciation and etc.) are encapsulated together by an object. Lemmas in the dictionary will be created through instancing of the object continually. Taking an electronic dictionary used in text processing as an example, FIG. 1 illustrates the problems existing in prior known electronic dictionaries. For simplicity, we assume the lemma in one of those dictionaries includes three attributes: name, part-of-speech and meaning. As shown in FIG. 1(a), the three attributes of the lemma are encapsulated together by an object. More specifically, these attributes are represented by a name variable, a part-of-speech tag and a meaning array, respectively. Among them, the name is used to represent the word in this lemma, for example, “fast” in FIG. 1(b); the part-of-speech tag is used to indicate the part-of-speech of the lemma, for example, in FIG. 1(c) a 8-bits byte is used to describe the part-of-speech of the lemma, each bit represents a particular part-of-speech (noun, verb and etc.). A bit with a value “1” indicates that the word has this part-of-speech. The meaning array is used for storing all meanings of the word in this lemma, for example, some of the meanings of the word “fast” are shown in FIG. 1(d) and 1 (e). In an electronic dictionary as shown in FIG. 1, once the design of the data structure is completed, new attributes cannot be added to the object unless a new data structure is designed. On the other hand, if the attributes of some lemmas change with user's new requirements, or new lemmas with different attributes need to be added into the dictionary, new objects need to be abstracted to represent the new lemmas with different attributes, and different identifiers need to be assigned to these new objects respectively. Since these objects represent the same real-world entity, i.e. a lemma in a dictionary, most attributes in these objects are same. This necessarily results in a large number of similar objects, leading to the problem of increased complexity in relationships among the objects. For example, in the electronic dictionary shown in FIG. 1, provided that the initial lemma of the dictionary only indicates a single word with its pronunciation, part-of-speech, meaning and semantic relations, and is abstracted by an object 01. However, in case of there is a requirement which needs the lemmas also include the idioms with meaning, semantic relation and headword (here, the headword is the core of an idiom which determines the basic meaning of the idiom) in the practical application, another object 02 has to be created to indicate these idioms with these necessary attributes. Both 01 and 02 represent lemmas in a dictionary, and many of their variables are the same, leading to data redundancy. Furthermore, since different identifiers are assigned to such objects, it is time and cost intensive to debug and maintain such a system.

U.S. Pat. No. 6,356,913 disclosed a dynamically modifiable database schema. As shown in FIG. 2, in this patent, a tree structure is used to represent a generic and dynamically modifiable database schema, including leaf nodes, branch container nodes, root nodes, attribute nodes and a map container node, different nodes having different data structures. Among them, each leaf node represents an instance of an attribute; each branch container node represents a different attribute and identifies those leaf nodes that represent instances of the container node's attributes; each root node represents a database record and identifies those leaf nodes in different container nodes that represents an instance of an attribute of the root node's record; each attribute node represents a different attribute and identifies the branch container node that represents that attribute; and the map container node identifies a plurality of attribute nodes.

It is possible to use above-mentioned generic and dynamically modifiable database schema to solve the problem of existing electronic dictionaries, i.e. a problem of whether it is possible to modify attributes of lemmas dynamically. Specifically, leaf nodes are used to store instances of attributes in respective lemmas, branch container nodes are used to store each type of attribute, and root nodes are used to store lemmas. Thus, if there is a need to add new attributes to a lemma, then a new branch container node is added and the corresponding leaf nodes are used to store the instances of the attributes. In addition, these leaf nodes are connected to the root node that represents the lemma. From the viewpoint of database, adding a new branch container node means defining a new table. So, though it is possible to dynamically modify attributes in a lemma by using U.S. Pat. No. 6,356,913, it has no maintainability due to the fact that in such a database schema all kinds of nodes are realized by using different tables in the database, and with different requirements proposed by users it is necessary to add and/or delete tables in the database frequently, so it is a complicated task to maintain such a system. Furthermore, in a tree data structure, each node has one and only one father node, i.e. a data element at a level can only relate to one element (i.e. father node) in the higher level. However, in electronic dictionaries, each child node may have more than one father nodes, that is, there is the situation that one attributes may be commonly used by some lemmas.

### SUMMARY OF THE INVENTION

Thus, in order to solve the problems of reusability and maintainability of existing electronic dictionaries, the present invention provides a user-oriented electronic dictionary for which a user may arbitrarily modify (add, delete) attributes in lemmas, electronic dictionary system and a method for creating same.

According to one aspect of the invention, a method is provided for creating/maintaining a user-oriented electronic dictionary, the method comprising following steps: defining an entity object for indicating a lemma or an attribute of a lemma in said electronic dictionary, said entity object comprising an entity name and an entity type; creating an entity instance library for storing entity instances generated from said entity object; defining a relation object for indicating a kind of directed relation between two entity objects, said relation object comprising a relation type, a source entity and a target entity; creating a relation instance library for storing relation instances—generated from said relation object, wherein all entity instances related to one lemma in said electronic dictionary are linked by the corresponding relation instances to form a directed relation graph; and dynamically adding a lemma, adding an attribute of a lemma, deleting a lemma or deleting an attribute of a lemma to or from said electronic dictionary by instancing said entity object and/or said relation object and performing operations on the instances in said entity instance library and said relation instance library.

According to another aspect of the invention, there is provided a user-oriented electronic dictionary, comprising: an entity instance library for storing a plurality of entity instances generated from an entity object, wherein said entity object is for indicating a lemma or an attribute of the lemma in said electronic dictionary and said entity object comprises an entity name and an entity type; a relation instance library for storing a plurality of relation instances generated from a relation object, wherein said relation object is for indicating a kind of directed relation between two entity objects and said relation object comprises a relation type, a source entity and a target entity, wherein all entity instances related to one lemma in said electronic dictionary are linked by the corresponding relation instances to form a directed relation graph.

According to still another aspect of the invention, there is provided a user-oriented electronic dictionary system, comprising: an entity instance library for storing a plurality of entity instances generated from an entity object, wherein said entity object is for indicating a lemma or an attribute of a lemma in said electronic dictionary and said entity object comprises an entity name and an entity type; a relation instance library for storing a plurality of relation instances generated from a relation object, wherein said relation object is for indicating a kind of directed relation between two entity objects and said relation object comprises a relation type, a source entity and a target entity, wherein all entity instances related to one lemma in said electronic dictionary are linked by the corresponding relation instances to form a directed relation graph; an entity maintaining means for instancing said entity object or dynamically modifying, adding or deleting entity instances in said entity object library; and a relation maintaining means for instancing said relation object or dynamically modifying, adding or deleting relation instances in said relation instance library.

### BRIEF DESCRIPTION OF THE DRAWINGS

These and other advantages, objectives and features will become clearer from the following description of preferred embodiments with reference to the accompanying drawings. Though in the following embodiments the invention is described by taking an electronic dictionary used in text processing as an example, it is obvious to those skilled in the art that the present invention should not be limited to the embodiments.

FIGS. 1(a)-1(e) show the composition of a lemma in a traditional electronic dictionary, wherein a lemma “fast” is taken as an example to illustrate it;

FIG. 2 shows an existing dynamically modifiable database schema;

FIG. 3 shows the composition of a lemma in an electronic dictionary according to the present invention;

FIG. 4 shows semantic relations between words in an electronic dictionary according to a preferred embodiment of the present invention;

FIGS. 5(a)-5(i) show how related lemma attributes form a lemma in an electronic dictionary according to a preferred embodiment of the present invention;

FIGS. 6(a)-6(e) show how to add new attributes into an existing lemma in an electronic dictionary according to a preferred embodiment of the present invention;

FIG. 7 is a flowchart showing steps of the method for creating an electronic dictionary according to the present invention;

FIG. 8 is a flowchart showing steps for adding or deleting a lemma/attribute in an electronic dictionary according to a preferred embodiment of the present invention;

FIG. 9 shows a case in which a redundancy relation may occur; and

FIG. 10 shows the composition of a user-oriented electronic dictionary system according to a preferred embodiment of the present invention.

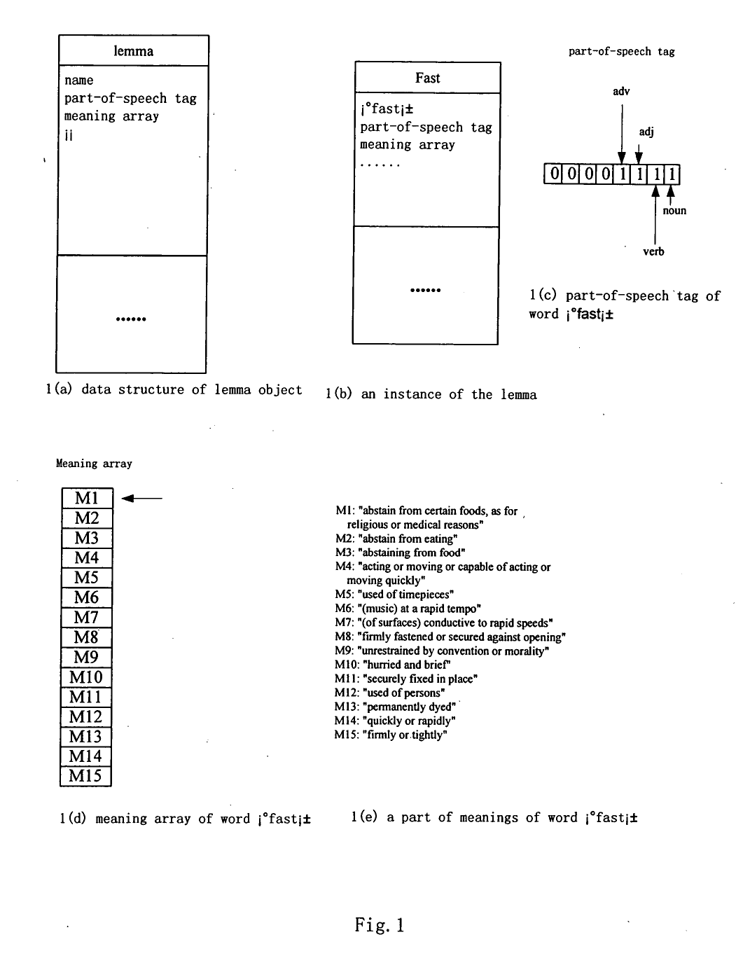

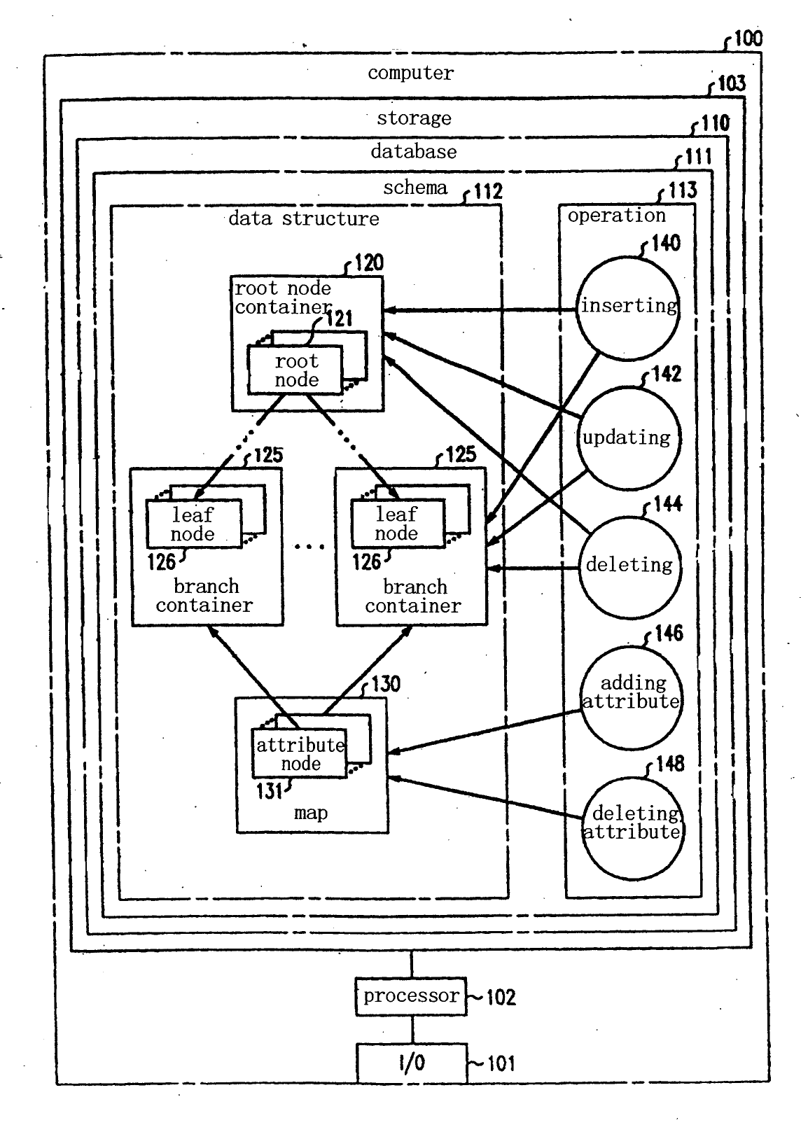

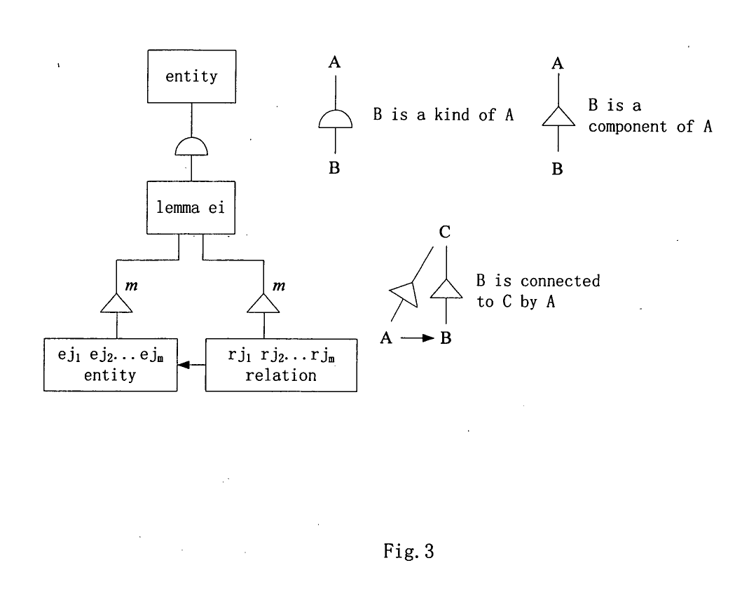

### DETAILED DESCRIPTION OF THE INVENTION

The present invention provides a user-oriented electronic dictionary for which a user may arbitrarily modify (add, delete) attributes in lemmas, electronic dictionary system and a method for creating same. This solve the problems of reusability and maintainability of existing electronic dictionaries.

In the present invention, an entity object is used to represent all kinds of information related to a lemma in a dictionary, such as pronunciation, meaning, part-of-speech and morphological form, etc., and a relation object is used to represent the relation between two entity objects and the relation is directed from the source entity to the target entity. Thus, in the electronic dictionary of the present invention, all entity instances related to one lemma are linked to it by the corresponding relation instances, which forms a directed relation graph. In the present invention, since each attribute related to a lemma is individually encapsulated into an entity object, when a user wants to add a new attribute to a lemma, what need to be done is simply to generate an entity instance corresponding to the attribute, and then to link the entity instance to the lemma, i.e., to add it to the directed relation graph of the lemma, through the corresponding relation instance. In this way, an attribute may be dynamically added to a lemma, while other attributes in the lemma are unchanged. Therefore the electronic dictionary generated by the present invention promises better reusability. Furthermore, since only one entity object is used to represent all kinds of attributes, the electronic dictionary generated by the present invention has the advantage of better maintainability as well.

In the invention, a method is provided for creating/maintaining a user-oriented electronic dictionary, the method comprising following steps: defining an entity object for indicating a lemma or an attribute of a lemma in said electronic dictionary, said entity object comprising an entity name and an entity type; creating an entity instance library for storing entity instances generated from said entity object; defining a relation object for indicating a kind of directed relation between two entity objects, said relation object comprising a relation type, a source entity and a target entity; creating a relation instance library for storing relation instances generated from said relation object, wherein all entity instances related to one lemma in said electronic dictionary are linked by the corresponding relation instances to form a directed relation graph; and dynamically adding a lemma, adding an attribute of a lemma, deleting a lemma or deleting an attribute of a lemma to or from said electronic dictionary by instancing said entity object and/or said relation object and performing operations on the instances in said entity instance library and said relation instance library.

In the present invention, there is provided a user-oriented electronic dictionary, comprising: an entity instance library for storing a plurality of entity instances generated from an entity object, wherein said entity object is for indicating a lemma or an attribute of the lemma in said electronic dictionary and said entity object comprises an entity name and an entity type; a relation instance library for storing a plurality of relation instances generated from a relation object, wherein said relation object is for indicating a kind of directed relation between two entity objects and said relation object comprises a relation type, a source entity and a target entity, wherein all entity instances related to one lemma in said electronic dictionary are linked by the corresponding relation instances to form a directed relation graph.

Also, in the invention, there is provided a user-oriented electronic dictionary system, comprising: an entity instance library for storing a plurality of entity instances generated from an entity object, wherein said entity object is for indicating a lemma or an attribute of a lemma in said electronic dictionary and said entity object comprises an entity name and an entity type; a relation instance library for storing a plurality of relation instances generated from a relation object, wherein said relation object is for indicating a kind of directed relation between two entity objects and said relation object comprises a relation type, a source entity and a target entity, wherein all entity instances related to one lemma in said electronic dictionary are linked by the corresponding relation instances to form a directed relation graph; an entity maintaining means for instancing said entity object or dynamically modifying, adding or deleting entity instances in said entity object library; and a relation maintaining means for instancing said relation object or dynamically modifying, adding or deleting relation instances in said relation instance library.

By means of the electronic dictionary, electronic dictionary system of the present invention and method for creating same, a user may dynamically add (modify, delete) attributes of a lemma without redesigning new data structures or adding new database tables. For example, if a user wants a lemma in a dictionary for text processing to further include an idiom, what need to be done by the user is simply to generate an entity instance ej corresponding to the idiom and a relation instance ra (ei′ej) that represents the relation between the entity instance ej and the lemma instance ei, in this way, the attribute, idiom may be added into the lemma. Specifically, after adding the corresponding entity instance and relation instance, the user may retrieve the entity instance ej through the lemma instance ei and relation instance ra(ei′ej) to obtain the idiom of the word. Furthermore, since other attributes in the lemma maintain unchanged, the electronic dictionary of the present invention promises better reusability. In addition, because only one entity object is used to represent all kinds of attributes of a lemma in the invention, the electronic dictionary of the invention has the advantage of easy maintaining as well. Besides, in the electronic dictionary of the present invention, an attribute value, i.e. an entity instance, may be commonly used by a plurality of lemmas, that is, the entity instance may be connected to different lemmas through corresponding relation instances.

Now a preferred embodiment of the present invention will be described in detail with reference to the accompanying drawings. FIG. 3 shows the composition of a lemma in an electronic dictionary according to the present invention. In the electronic dictionary of the invention, an entity object is used to represent a lemma and its related attributes, such as a word's pronunciation, meaning, part-of-speech and morphological form, etc., and a relation object is used to represent the relation between two entity objects and the relation is directed, the two entity objects linked by a relation object are called source entity and target entity, respectively. Thus, as shown in FIG. 3, in the electronic dictionary according to the invention, each lemma itself is an instance of a kind of entity object, meanwhile the lemma is composed of a plurality of entity instances, the related entity instances are linked by the relation instances to form a directed relation graph. In FIG. 3, m indicates the number of attributes included in a lemma. It can be seen from FIG. 3 that, in the electronic dictionary according to the invention, if a lemma includes m attributes, then m+1 entity instances and m relation entity instances are needed to represent this lemma, one of the m+1 entity instances, ei, represents the lemma, the other m entity instances ej₁, ej₂, . . . ejₘ represent m attributes of the lemma, and these m entity instances are linked to the entity instance ei through the m relation instances rj₁, rj₂, . . . rjₘ, respectively.

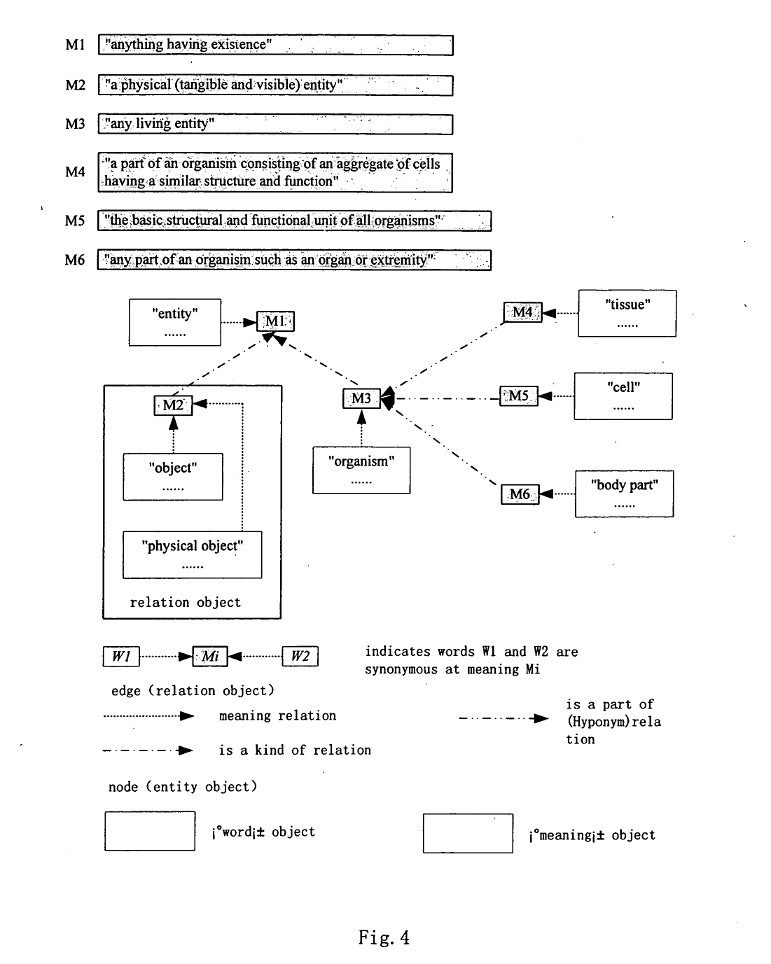

Referring FIG. 4, the semantic relation between words in the electronic dictionary is taken as an example to further explain how related entity instances are linked through relation instances. In the figure, a node block corresponds to an entity instances, and an edge corresponds to a relation instance. Among them, a white block represents a word instance, for example, “entity”, “object”, “physical object”, “organism”, “body”, “tissue”, “cell”, “body part” and etc., and a block with gray background represents a meaning instance. FIG. 4 shows six meaning instances M1, M2, M3, M4, M5 and M6. FIG. 4 also shows relation instances used for indicating relations between entity instances, for example, “meaning relation”, “is a part of relation” and “is a kind of relation”, these relation instances are indicated by different dot lines in the figure. Since these relations between entity instances are directed relations, the dot lines in the figure have arrows with them. For example, the relation between word instance “entity” and meaning instance M1 is a “meaning relation”, the relation's direction is from “entity” to M1, for the convenience of description, we call “entity” as a source entity and M1 as a target entity. The relation between meaning instances M1 and M2 is “is a part of relation”, and the relation between meaning instances M4 and M3 is “is a kind of relation”. If two word instances W1 and W2 are linked to the same meaning instance M1 through respective relation instance, it is indicated that W1 and W2 are synonymous at meaning M1. FIG. 4 only schematically describes semantic relations, but this method may also be used to describe all kinds of relations in an electronic dictionary.

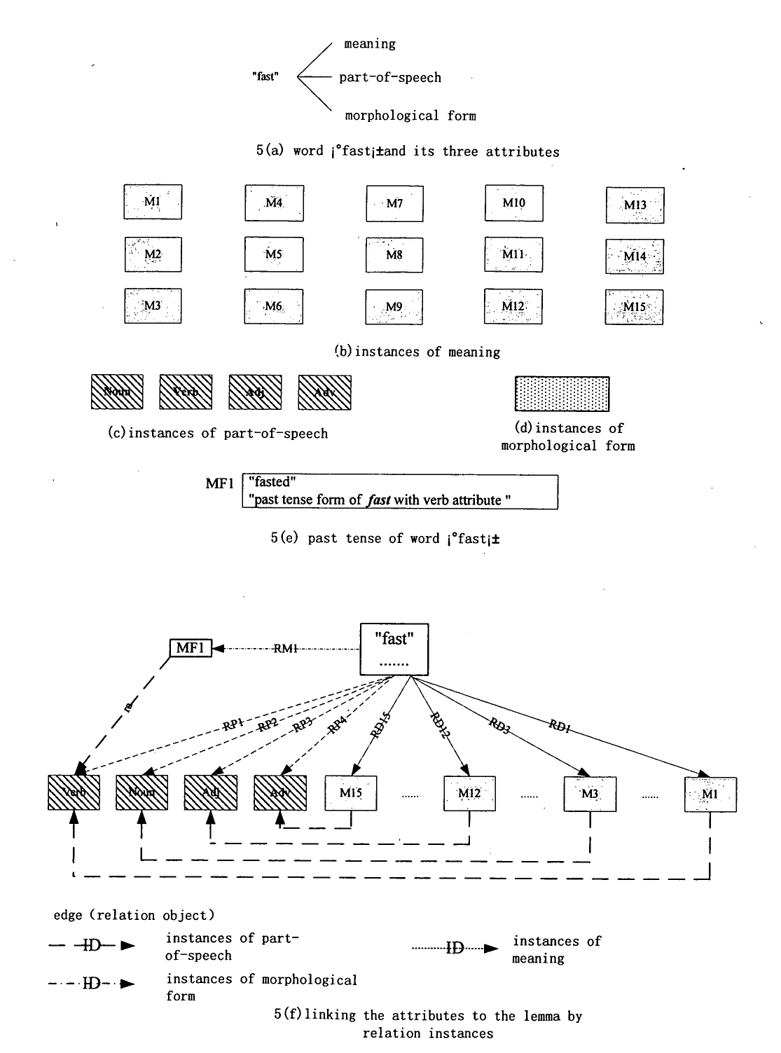

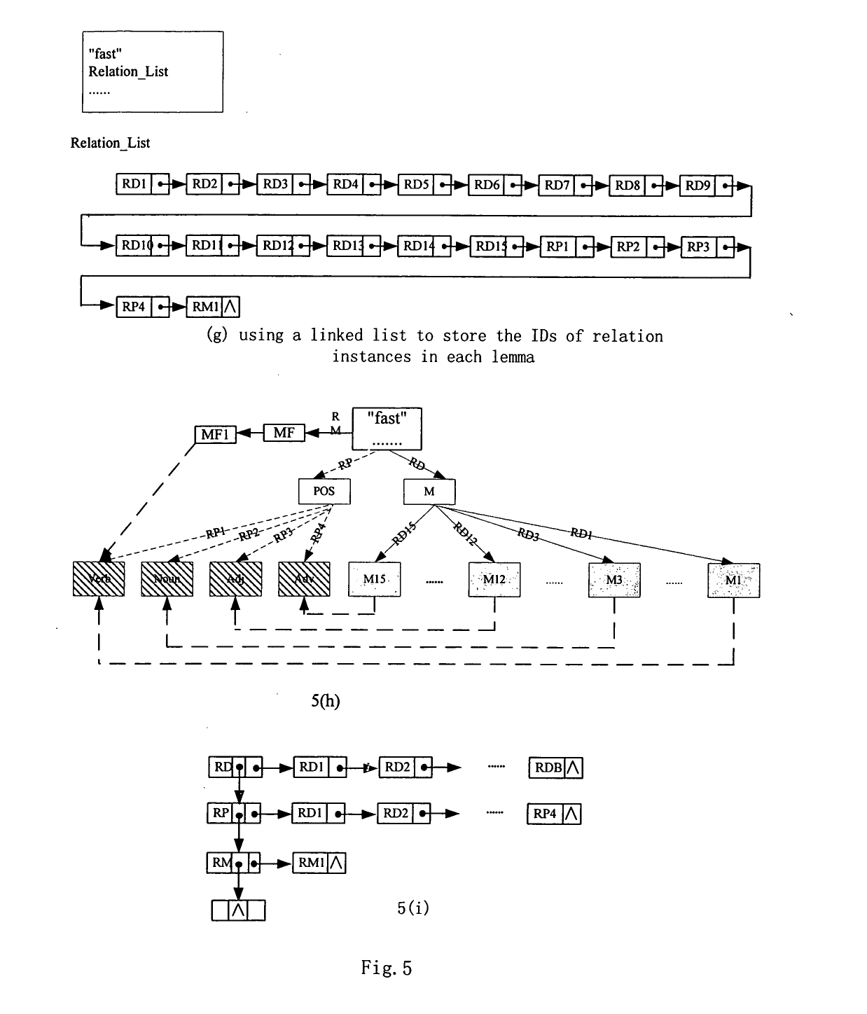

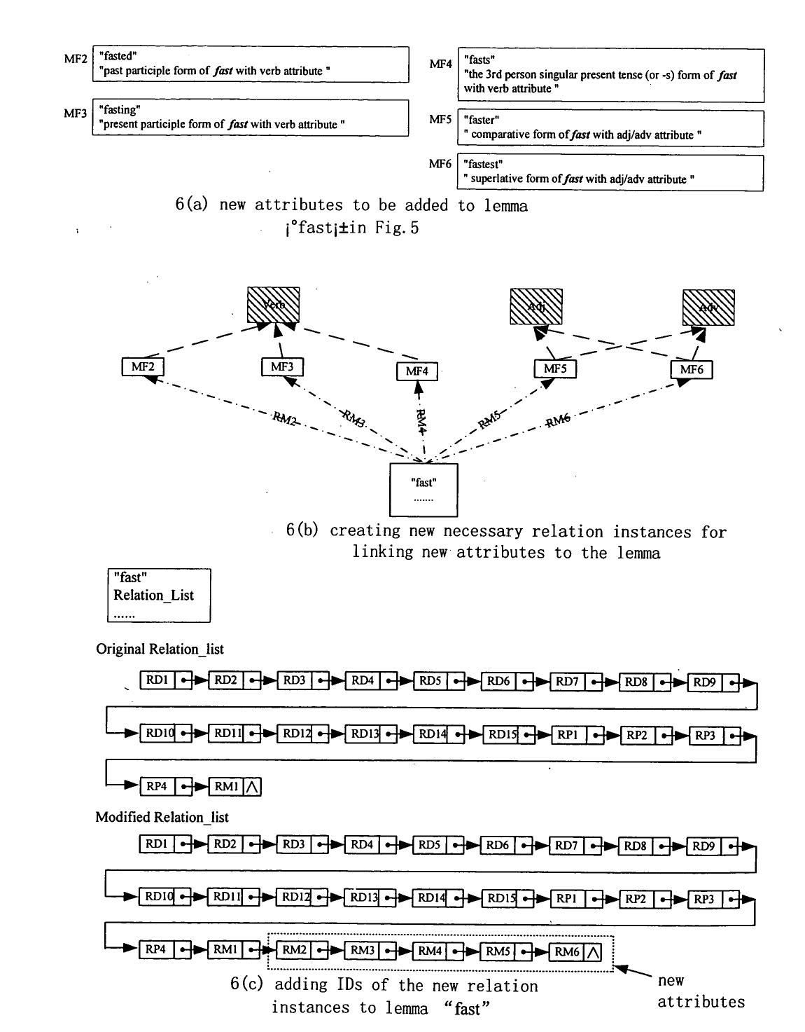

With reference to FIG. 5 a description will be given to show how related lemma attributes are organized to form a lemma in an electronic dictionary according to a preferred embodiment of the present invention.

For simplicity, only three attributes are considered in this embodiment: meaning, part-of-speech and morphological form of a word, as shown in FIG. 5(a). These attributes are represented by three kinds of entity instances, respectively, that is, meaning instance, part-of-speech instance and morphological form instance, as shown in FIG. 5(b), 5(c) and 5(d), different blocks are used to represent these attribute instances. Among them, M1 is a word meaning, as shown in FIG. 5(e), i=1, . . . 15. These attribute instances are linked to the lemma instance “fast” through corresponding relation instances RD1 . . . RD15, RP1 . . . RP4 and RM1 forming a directed relation graph as shown in FIG. 5(f). The lemma “fast” itself is also an entity instance. In addition, FIG. 5(f) also shows the relations between meaning instance and part-of-speech instance as well as morphological form instance. Thus, in the electronic dictionary according to the present invention, not only can all of the attributes of the lemma be obtained from the lemma instance and its related relation instances, but also all other entity instances related to any one of entity instances can be found through this entity instance (e.g. meaning instance M1) and its related relation instance.

In order to facilitate maintenance, in the preferred embodiment all entity objects have the same attributes:

Name: entity name;

Type Tag: entity type;

Directed Relation Graph: after a entity object is instanced, the directed relation graph thereof is used to store identifiers (IDs) of all relation instances that represent the relations between the entity instance and other entity instances.

Accordingly, in the preferred embodiment, entity instance “fast” may be represented as:

Name: fast;

Type Tag: 1 (indicating a lemma instance);

Directed Relation Graph: RD1, RD2 . . . RD15, RP1, RP2, RP3, RP4, RM1.

The entity instance MF1 may be represented as:

Name: “fasted”;

Type Tag: 2 (indicating a morphological form instance);

Directed Relation Graph: ra.

Besides, in the preferred embodiment, all relation objects also have the same attributes:

Type Tag: relation type;

Source Entity: origin point of the relation;

Target Entity: ending point of the relation.

Table 1 shows the relation types existing in the preferred embodiment.

Table 1 the relation types existing in the preferred embodiment

| | | Type |
|---|---|---|
| Type | Description | Tag |
| Part-of-speech | Connecting the part-of-speech instance of a word | 1 |
| Relation | to the lemma instance, used for indicating the | |
| | part-of-speech of a word | |
| Meaning | Connecting the meaning instance of a word to the | 2 |
| Relation | lemma instance | |
| Morphological | Connecting the morphological form instance of a | 3 |
| Form Relation | word to the lemma instance | |
| Synonym | Connecting the synonym instance of a word to the | 4 |
| Relation | lemma instance | |
| Antonym | Connecting the antonym instance of a word to the | 5 |
| Relation | lemma instance | |
| Hypernym | Y is a hypernym of X if X is a kind of Y | 6 |
| Hyponym | X is a hyponym of Y if X is a kind of Y | 7 |
| Holonym | Y is a holonym of X if X is a part of Y | 8 |
| Meronym | X is a meronym of Y if X is a part of Y | 9 |
| Constraint | Used to constrain a relation that is valid under | 10 |
| Relation | specific conditions | |

Here, the Constraint Relation is used to constrain a relation that is valid under specific conditions, that is, if an entity E1 has a relation Ra with entity E2 under the condition that E1 has a relation Rb with entity E3, then E2 has a relation Rc with E3. For example, as shown in FIG. 5(f), the word entry “fast” has a relation with meaning M1 under the condition that “fast” has a relation with attribute Verb, then M1 has a relation with Verb.

Accordingly, in the preferred embodiment, relation instance “RD1” may be represented as:

Type Tag: 2;

Direction Tag: 1 (single direction);

Source Entity: “fast”;

Target Entity: “Verb”.

In order to facilitate modifying the attributes of a lemma dynamically, as shown in FIG. 5(g), in the preferred embodiment according the present invention, a linked list is used to store the IDs of all relation instances in the lemma. Thus, if there is a need to find a lemma, such as the lemma “fast”, what need to be done is simply to find an entity instance with the entity type as “lemma” and the entity name as “fast”, then all attributes of the lemma can be found according to the directed relation graph of the entity instance. In addition, alternatively, only a pointer pointing to a relation list is stored in the directed relation graph of the entity object.

It should be noted that, in the preferred embodiment, since each entity instance includes a directed relation graph, it is very easy to find other entity instances related to the entity instance. As shown in FIG. 5(f), from the directed relation graph of the lemma instance “fast”, all attributes of the lemma may be obtained, such as Verb, Noun, Adj. and etc. And for the attribute instance “M1”, it is also possible to find related entity instance “Verb” from its directed relation graph. Although an directed relation graph of attributes is included in the entity object in the preferred embodiment in order to facilitate maintenance and to improve searching speed, as appreciated by those skilled in the art, all attributes related to a lemma may be found even the entity object does not include the attribute “directed relation graph”. For example, for finding all attributes of the lemma “fast”, an entity instance named as “fast” is found first, and then all relation instances with “fast” as the source entity, RD1 . . . RD3 . . . RD15 . . . RP1 . . . RP4 and RM1, are found, thereafter, all attributes of the lemma, such as M1, M2 . . . M15, Verb . . . MF1, will be found.

In addition, in order to further improve searching speed, a hierarchical structure as shown in FIG. 5(h) may be used to link all attributes of a lemma, and a second-level linked list, as shown in FIG. 5(i), is used to store IDs of all relation instances of the lemma. The difference between FIG. 5(f) and 5(h) is that there are entity instances added in FIG. 5(h), including part-of-speech (entity) instance “POS”, meaning (entity) instance “M” and morphological form (entity) instance “MF”, as well as corresponding relation instances, i.e. morphological form (relation) instance “RM”, part-of-speech (relation) instance “RP” and meaning (relation) instance “RD”. All attributes of a lemma may be classified by these instances and linked by a hierarchical structure, in this way, the searching speed may be further improved.

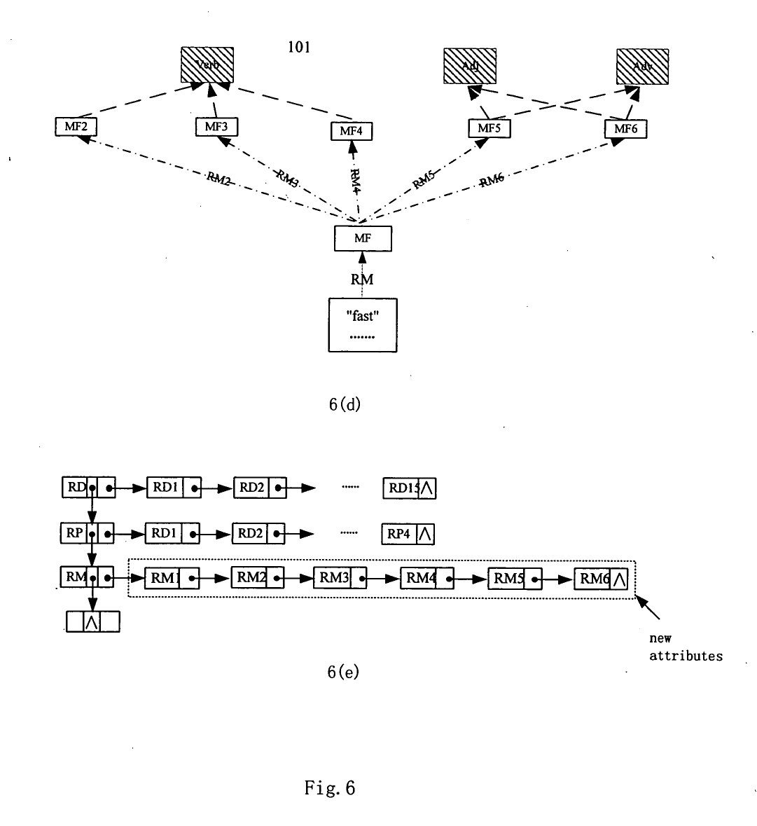

Next, referring FIG. 6, it will be described how to add new attributes for the lemma “fast”. As shown in FIG. 6(a), the entity instances corresponding to the new attributes to be added are MF2, MF3, MF4, MF5 and MF6. For adding these attributes to the lemma “fast”, new relation instances, i.e. RM2, RM3, RM4, RM5 and RM6 (FIG. 6(b)), need to be generated first, and then the IDs of these relation instances should be added into the relation list (FIG. 6(c)).

FIG. 6(d) and 6(e) show how to add new attributes for a lemma so as to improve searching speed when a hierarchical structure is used to link all attributes about the lemma and a second-level linked list is used to store the relation instances of the lemma.

In above, it has been described in detail how to use entity objects and relation objects to represent lemmas and their attributes in the electronic dictionary according to the present invention. From above it can be seen that a user-oriented electronic dictionary according to the present invention should include an entity instance library and a relation instance library to store a plurality of entity instances generated from an entity object and a plurality of relation instances generated from a relation object, respectively, wherein each entity instance represents a piece of information related to a lemma in said electronic dictionary, each relation instance represents a relation between a source entity and a target entity, and all entity instances related to one lemma in said electronic dictionary are linked through the corresponding relation instances to form a directed relation graph.

From above, it also can be seen that, in the electronic dictionary according to the present invention, if a new attribute is to be added to a lemma, what need to be done is simply to generate an entity instance corresponding to the attribute to be added, and to add the entity instance into the directed relation graph of the lemma through the corresponding relation instance, in this way, an attribute may be added dynamically, at the same time, other attributes in the lemma maintain unchanged, so that the electronic dictionary of the present invention promises better reusability. Furthermore, since the attribute values of all lemmas are the instances generated from the same entity object, the electronic dictionary of the present invention promises better maintainability as well. Besides, all attribute values may be commonly used by a plurality of lemmas.

Next, how to create a user-oriented electronic dictionary will be described in detail with reference to the drawings.

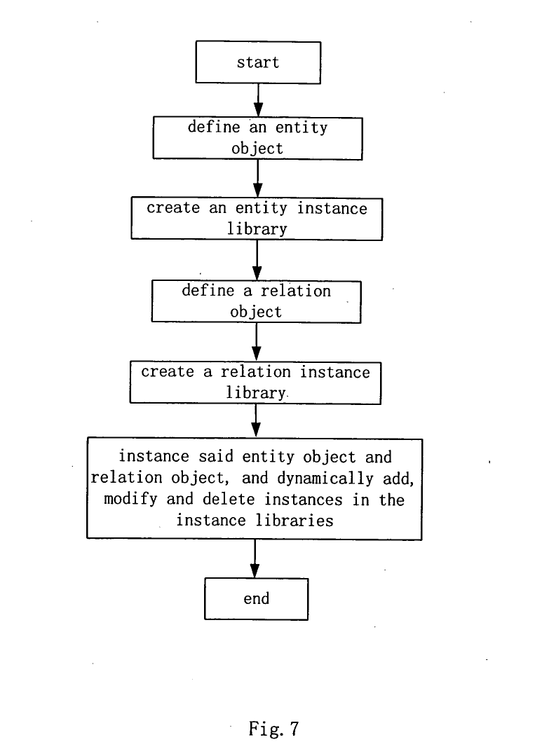

As shown in FIG. 7, following steps are comprised for creating a user-oriented electronic dictionary:

Defining an entity object for indicating a lemma or an attribute of a lemma in said electronic dictionary, the entity object comprising an entity name and an entity type;

Creating an entity instance library for storing entity instances generated from said entity object;

Defining a relation object for indicating a kind of directed relation between two entity objects, said relation object comprising a relation type, a source entity and a target entity;

Creating a relation instance library for storing relation instances generated from said relation object, wherein all entity instances related to one lemma in said electronic dictionary are linked by the corresponding relation instances to form a directed relation graph; and

Dynamically adding a lemma, adding an attribute of a lemma, deleting a lemma or deleting an attribute of a lemma to or from said electronic dictionary by instancing said entity object and/or said relation object and performing operations on the instances in said entity instance library and said relation instance library.

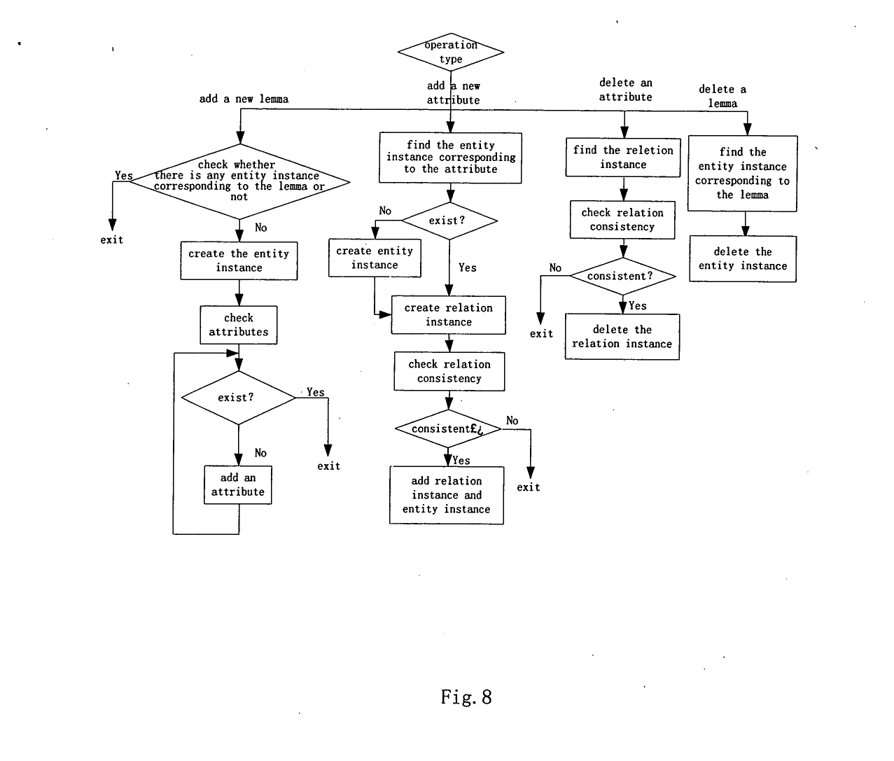

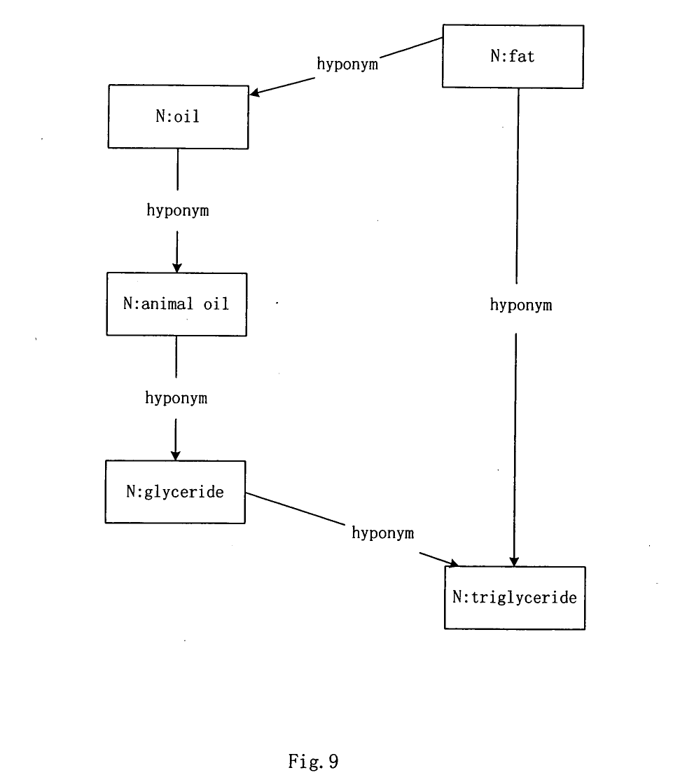

Specifically speaking, as shown in FIG. 8, operations on an electronic dictionary may be divided into following types of operations:

1. Adding a new lemma;

2. Adding a new attribute;

3. Deleting an attribute; and

4. Deleting a lemma.

Through an iterative execution of the processes for adding new lemmas and new attributes and dynamical modification (adding or deleting) of entity instances and relation instances in the instance library of the electronic dictionary, a user-oriented electronic dictionary according to the present invention can be created, and users can also use these processes to add or delete lemmas/attributes of lemmas without redesigning new data structure, so that the electronic dictionary according to the present invention promises better reusability.

Next, referring to FIG. 8, detail description will be given to these operations.

Adding a New Lemma

Step 1: check whether there is the lemma in the electronic dictionary, in the case of the embodiment shown in FIG. 5, this is to check whether there is any entity instance which has “lemma” as its entity type and the word to be added as its entity name;

Step 2: if the lemma does not exist, create the entity instance corresponding to the lemma and add necessary attributes to it.

Adding a New Attribute to an Existing Lemma

Step 1: find the entity instance ei corresponding to the lemma, and find the entity instance ej corresponding to the attribute, if it does not exist, create the entity instance ej;

Step 2: create a relation instance ra for connecting ej to ei;

Step 3: check whether the newly created relation instance ra is consistent with the existing relation instances in the relation instance library. If so, add the relation instance ra to the directed relation graph of the entity instance ei. So called “adding the relation instance ra to the directed relation graph of the entity instance ei” refers to adding ra to the relation instance library, and in the case of the embodiment shown in FIG. 4, not only adding ra into the relation instance library but also adding the ID of the relation instance to the relation list of the entity instance ei.

In the embodiment of the present invention, checking the consistency of a relation is mainly to check whether the relation is redundant, conflict or insufficient.

Redundant

1. If two relation instances have the same type, the same source entity instance and the same target entity instance, these two relation instances are considered to be redundant.

2. If the source entity instance of a relation instance is the same as the target entity instance of the relation instance, the relation instance is considered to be redundant.

3. A redundant relation caused by the transitivity of a quasi-hierarchical relation. In FIG. 8, the lower position relation from “fat” to “triglyceride” is redundant.

Conflicting

1. If a relation is of single direction, then it is impossible for R(A′B) and R(B′A) to exist at the same time, wherein R(A′B) means a relation that starts at object A and ends at object B.

2. If R is defined over A×B, then r(x, y) belonging to R should inherit to x belonging to A and y belonging B.

Insufficient

1. Attribute: type, starting point and ending point are necessary components of a relation, if one of them is absent, the relation is insufficient.

2. Attribute: type and name are necessary components of an entity object, if one of them is absent, the entity object is insufficient.

Above are only some examples for consistency checking, for a specific application, further completion may be required.

Next, an introduction will be given to the operation of deleting an attribute from an entity instance ei:

Step 1: find the relation instance ra connecting the attribute to the entity instance ei;

Step 2: check whether the existing relation instances would be consistent to each other after the relation instance ra should have been deleted;

Step 3: if so, delete the relation instance from the directed relation graph of ei.

So called “deleting relation instance ra from the directed relation graph of the entity instance ei” refers to deleting relation instance ra from the relation instance library, and in the case of the embodiment shown in FIG. 4, refers to deleting ID of the relation instance from the relation list of the entity instance ei.

In addition, the method according the present invention further comprises the operation of deleting a lemma, that is, finding the entity instance corresponding to the lemma and deleting the entity instance.

In addition to the aforementioned operations on entity instances, the method of the present invention further comprises operations on relation objects, i.e., creating a relation instance/deleting an existing relation instance. Checking of the relation consistency should be done before adding a newly created relation instance into the relation instance library and deleting an existing relation instance from the relation instance library.

In above, the method of creating a user-oriented electronic dictionary according to a preferred embodiment of the present invention has been described in detail.

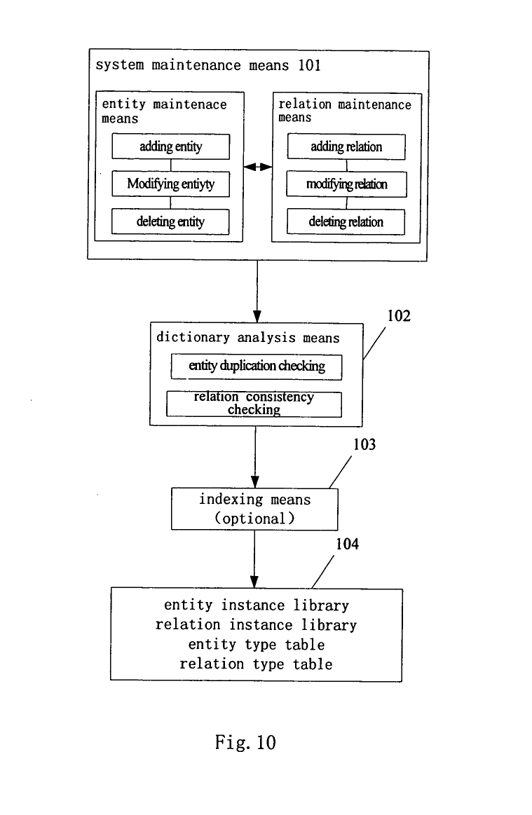

FIG. 10 shows the composition of an electronic dictionary system according to a preferred embodiment of the present invention. As shown in FIG. 10, the system comprises: a system maintenance means 101, a dictionary analysis means 102, a indexing means 103 and a database 104. Next, the components of the system will be described in detail with reference to the drawing. As shown in FIG. 10, the database 104 comprises an entity instance library, a relation instance library, an entity type table and an relation type table, wherein the entity instance library is used to store a plurality of entity instances generated from an entity object, each entity instance represents a piece of information related to a lemma in said electronic dictionary; the relation instance library is used to store a plurality of relation instances generated from a relation object, each relation instance represents a relation between two entity instances, the relation is a directed relation, wherein all entity instances related to one lemma in said electronic dictionary are linked by the corresponding relation instances to form a directed relation graph; the entity type table is used to store entity types that are allowed to exist in the electronic dictionary system; the relation type table is used to store relation types that are allowed to exist in the electronic dictionary system. The system maintenance means 101 comprises an entity maintenance means and a relation maintenance means, wherein the entity maintenance means is used to instance the entity object or dynamically modify, add or delete entity instances in said entity instance library; the relation maintenance means is used to instance the relation object or dynamically modify, add or delete relation instances in said relation instance library. The dictionary analysis means 102 comprises an entity duplication checking and deleting means and a relation consistency checking means, wherein the entity duplication checking and deleting means is used to delete duplicate entity instances and the relation consistency checking means is used to check the relation consistency, mainly to check whether the relation is redundant, conflict or insufficient. Besides, for further raising the system's searching speed, an indexing means 103 is included as well in the electronic dictionary system according to the preferred embodiment of the present invention.

Although in above, taking an electronic dictionary in text processing as an example, a description has been given to an electronic dictionary, the electronic dictionary system and the method for creating same according to the present invention, for which users can dynamically modify attributes of a lemma. Those skilled in the art will appreciate that the present invention is applicable to any electronic dictionary of information processing for collecting attributes, usages of data and their relations with other data.

Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

What is claimed, is:

1. A method for creating a user-oriented electronic dictionary, comprising:
defining an entity object, for indicating a lemma or an attribute of a lemma in said electronic dictionary, said entity object comprising an entity name and an entity type;
creating an entity instance library, for storing entity instances generated from said entity object;
defining a relation object, for indicating a kind of directed relation between two entity objects, said relation object comprising: a relation type, a source entity and a target entity;
creating a relation instance library, for storing relation instances generated from said relation object; wherein all entity instances related to a lemma in said electronic dictionary are linked by the corresponding relation instances to form a directed relation graph; and
dynamically adding a lemma, adding an attribute of a lemma, deleting a lemma or deleting an attribute of a lemma to or from said electronic dictionary by instancing said entity object and/or said relation object and performing operations on the instances in said entity instance library and said relation instance library.

2. The method according to claim 1, wherein said entity object further comprises a directed relation graph attribute, after said entity object is instanced, the IDs of all relation instances for indicating the relations between the newly generated entity instance and other entity instances are stored in the directed relation graph of the newly generated entity instance.

3. The method according to claim 2, wherein in said directed relation graph of said entity instance, a linked list is used to store said IDs.

4. The method according to claim 3, wherein in said directed relation graph of said entity instance, only a pointer pointing to said linked list is stored.

5. The method according to claim 1, wherein the step of adding a lemma to said electronic dictionary comprises:
determining if there exists an entity instance corresponding to the lemma to be added in said entity instance library or not;
if there does not exist, generating an entity instance corresponding to the lemma, and adding it into said entity instance library; and
determining if it is needed to add attributes to the lemma, if it is needed, adding attributes to the lemma.

6. The method according to claim 1, wherein the step of adding an attribute of a lemma to said electronic dictionary comprises:
determining if there exists an entity instance corresponding to the attribute in said entity instance library or not;
if there does not exist, generating an entity instance corresponding to the attribute;
generating a relation instance, for linking the newly generated entity instance to the lemma; and
adding the newly generated entity instance into the directed relation graph of the lemma.

7. The method according to claim 6, wherein the step of adding an attribute of a lemma comprises the step of relation consistency checking: checking if the newly generated relation instance is consistent with the existing relation instances in said relation instance library, and only if consistent, adding the newly generated relation instance into the directed relation graph of the lemma.

8. The method according to claim 7, wherein the step of relation consistency checking comprises the steps of relation redundancy, conflict or deficiency checking.

9. The method according to claim 1, wherein the step of deleting an attribute of a lemma from said electronic dictionary comprises:
finding the entity instance corresponding to the attribute and the relation instance for linking the entity instance to the lemma in said entity instance library and said relation instance library; and
deleting the found relation instance from the directed relation graph of the lemma.

10. The method according to claim 9, wherein the step of deleting an attribute of a lemma further comprises the step of relation consistency checking: checking if other relation instances in said relation instance library are consistent when deleting the found relation object relation instance, and only if consistent, deleting the found relation instance from the directed relation graph of the lemma.

11. The method according to claim 10, wherein the step of relation consistency checking comprises the steps of relation redundancy, conflict or deficiency checking.

12. The method according to claim 1, wherein the step of deleting a lemma from said electronic dictionary comprises:
finding the entity instance corresponding to the lemma in said entity instance library; and
deleting the found entity instance from said entity instance library.

13. A user-oriented electronic dictionary, comprising:
an entity instance library, for storing a plurality of entity instances generated from an entity object, said entity object for indicating a lemma or an attribute of a lemma in said electronic, and said entity object comprising an entity name and an entity type;
a relation instance library for storing a plurality of relation instances generated from a relation object, said relation object for indicating a kind of directed relation between two entity objects, and said relation object comprising: a relation type, a source entity and a target entity; wherein all entity instances related to a lemma in said electronic dictionary are linked by the corresponding relation instances to form a directed relation graph.

14. The dictionary according to claim 13, wherein said entity object further comprises a directed relation graph attribute, after said entity object is instanced, the IDs of all relation instances for indicating the relations between the newly generated entity instance and other entity instances are stored in the directed relation graph of the newly generated entity instance.

15. The dictionary according to claim 14, wherein in said directed relation graph of said entity instance, a linked list is used to store said IDs.

16. The dictionary according to claim 15, wherein in said directed relation graph of said entity instance, only a pointer pointing to said linked list is stored.

17. A user-oriented electronic dictionary system, comprising:
an entity instance library, for storing a plurality of entity instances generated from an entity object, said entity object for indicating a lemma or an attribute of a lemma in said electronic dictionary, and said entity object comprising an entity name and an entity type;
a relation instance library for storing a plurality of relation instances generated from a relation object, said relation object for indicating a kind of directed relation between two entity objects, and said relation object comprising: a relation type, a source entity and a target entity; wherein all entity instances related to a lemma in said electronic dictionary are linked by the corresponding relation instances to form a directed relation graph;
an entity maintaining means for instancing said entity object, or dynamically adding, modifying or deleting entity instances in said entity instance library; and
a relation maintaining means for instancing said relation object, or dynamically adding, modifying or deleting relation instances in said relation instance library.

18. The system according to claim 17, wherein said system further comprises a dictionary analysis means for performing relation consistency check.

19. The method according to claim 1, further comprising employing said method for maintaining said user-oriented electronic dictionary.

20. An article of manufacture comprising a computer usable medium having computer readable program code means embodied therein for causing creation of a user-oriented electronic dictionary, the computer readable program code means in said article of manufacture comprising computer readable program code means for causing a computer to effect the steps of claim 1.

21. A program storage device readable by machine, tangibly embodying a program of instructions executable by the machine to perform method steps for creating a user-oriented electronic dictionary, said method steps comprising the steps of claim 1.

22. A computer program product comprising a computer usable medium having computer readable program code means embodied therein for causing a user-oriented electronic dictionary, the computer readable program code means in said computer program product comprising computer readable program code means for causing a computer to effect the functions of claim 13.

23. A computer program product comprising a computer usable medium having computer readable program code means embodied therein for causing a user-oriented electronic dictionary system, the computer readable program code means in said computer program product comprising computer readable program code means for causing a computer to effect the functions of claim 17.
